(19) United States
(12) Patent Application Publication
(10) Pub. No.: US 2019/0134728 A1
(43) Pub. Date: May 9, 2019

(54) WIRE ELECTRIC DISCHARGE MACHINE, GUIDE UNIT, AND WIRE ELECTRIC DISCHARGE MACHINING METHOD

(71) Applicant: Mitsubishi Electric Corporation, Chiyoda-ku (JP)

(72) Inventors: Hidetaka KATOGI, Tokyo (JP); Nobuyuki SUMI, Tokyo (JP)

(73) Assignee: Mitsubishi Electric Corporation, Chiyoda-ku (JP)

(21) Appl. No.: 16/096,005

(22) PCT Filed: Jul. 7, 2016
(86) PCT No.: PCT/JP2016/070184

§ 371 Date: Oct. 24, 2018

(51) Int. Cl. B23H 7/10; B23H 7/06; B23H 7/26; B23H 7/18

(52) U.S. Cl. CPC B23H 7/105; B23H 7/06; B23H 7/18; B23H 7/26; B23H 7/108

(57) ABSTRACT

A guide unit that stretches a wire electrode and guides the wire electrode to a machinable range section where a workpiece is placed includes: a first wire guide and a second wire guide; a first support element disposed spaced apart between the first and second wire guides and disposed spaced apart from the first wire guide, which determines a passage location of the wire electrode; and a second support element disposed spaced apart from the second wire guide, which determines a passage location of the wire electrode. The first support element has a variable direction relative to the first wire guide, the machinable range section of the wire electrode is formed of a portion stretched between the first and second support elements, and the wire electrode can tilt with respect to the wire electrode supplied from the supply unit.

### FIELD

The present invention relates to a wire electric discharge machine, a guide unit, and a wire electric discharge machining method, each capable of changing a moving direction of a wire electrode.

### BACKGROUND

Wire electric discharge machines include a machining apparatus of a type that causes a wire electrode to move vertically to draw a desired shape on top and bottom surfaces of a workpiece, and a machining apparatus of a type that causes a wire electrode to move horizontally to draw a desired shape on a side surface of a workpiece.

Both the foregoing types of machining apparatuses perform machining while supplying a machining fluid such as deionized water, aqueous solution, or electrical insulating oil over a machining range. In a machining apparatus of a type that causes a wire electrode to move vertically, a machining range in which a workpiece can be machined depends on a distance, i.e., a heightwise distance between upper and lower wire guides. For this reason, if a longitudinal workpiece extends beyond the distance between the upper and lower wire guides, it cannot be subjected to machining process. Also in a machining apparatus of a type that causes a wire electrode to move horizontally, a workpiece cannot be fixed on a table surface plate, thereby making that type inappropriate for machining of a heavy workpiece.

Patent Literature 1 discloses a technique for performing horizontal machining and tilt machining by using an electric discharge machining jig composed of a wire electrode and interchanging multiple removable guide arms.

### CITATION LIST

### Patent Literature

Patent Literature 1: Japanese Utility Model Application Laid-open No. H01-004520

### SUMMARY

### Technical Problem

However, it has been difficult for the technique of Patent Literature 1 to provide flexibility in machining direction, and it has been particularly difficult to change the machining direction in the process of a machining operation. This has presented a problem in that continuous machining in different directions is difficult while the workpiece is being fixed.

The present invention has been made in view of the foregoing circumstances, and it is an object of the present invention to provide a wire electric discharge machine capable of freely changing the machining direction, and expanding the machining range.

### Solution to Problem

In order to solve the problem described above, the present invention comprises: a supply unit to supply a wire electrode; and a wire guide unit to stretch the wire electrode in motion supplied from the supply unit, and guide the wire electrode to a machinable range section where a workpiece is placed. The wire guide unit includes: a first wire guide; a second wire guide disposed spaced apart from the first wire guide and movable relative to the first wire guide; a first support element disposed spaced apart from the first wire guide between the first and second wire guides to determine a passage location of the wire electrode; and a second support element disposed spaced apart from the second wire guide to determine a passage location of the wire electrode and control a tilt of a line segment connecting the first and second support elements.

### Advantageous Effects of Invention

The present invention has an advantageous effect of providing a wire electric discharge machine capable of freely changing the machining direction, and expanding the machining range.

### BRIEF DESCRIPTION OF DRAWINGS

FIG. 1 is a front view schematically illustrating a wire electric discharge machine according to a first embodiment of the present invention.

FIG. 2 is a side view schematically illustrating the wire electric discharge machine according to the first embodiment of the present invention.

FIG. 3 is a front view illustrating the wire electric discharge machine according to the first embodiment of the present invention, the machine having a state in which a direction of the wire electrode is tilted.

FIG. 4 is a perspective view of the guide unit of the wire electric discharge machine according to the first embodiment of the present invention as viewed from the front.

FIG. 5 is a perspective view of the guide unit of the wire electric discharge machine according to the first embodiment of the present invention as viewed from the rear.

FIG. 6 is an illustrative diagram illustrating a concept of the wire electric discharge machine according to the first embodiment of the present invention.

FIG. 7 is another illustrative diagram illustrating a concept of the wire electric discharge machine according to the first embodiment of the present invention.

FIG. 8 is still another illustrative diagram illustrating a concept of the wire electric discharge machine according to the first embodiment of the present invention.

FIG. 9 is an illustrative diagram illustrating a positional relationship between the first support element and the second support element of the wire electric discharge machine according to the first embodiment of the present invention.

FIG. 10 is an enlarged illustrative view of a main portion of the first wire guide of the wire electric discharge machine according to the first embodiment of the present invention.

FIG. 11 is an illustrative diagram illustrating a main coordinate system defined by first and second units in the wire electric discharge machine according to the first embodiment of the present invention.

FIG. 12 is an illustrative diagram illustrating an auxiliary coordinate system defined by the second unit in the wire electric discharge machine according to the first embodiment of the present invention.

FIG. 13 is a flowchart illustrating a wire electric discharge machining process using the wire electric discharge machine according to the first embodiment of the present invention.

FIG. 14 is a diagram illustrating hardware configuring a control unit of the wire electric discharge machine according to the first embodiment of the present invention.

FIG. 15 is a schematic diagram of which (a) to (e) illustrate the positions of the guide unit in the sequence of machining processes in the main coordinate system.

FIG. 16 is a flowchart illustrating a wire electric discharge machining process using the wire electric discharge machine according to the first embodiment of the present invention.

FIG. 17 is a schematic diagram of which (a) to (e) illustrate the positions of the guide unit in the sequence of machining processes in the auxiliary coordinate system.

FIG. 18 is a flowchart illustrating a wire electric discharge machining process using the wire electric discharge machine according to the first embodiment of the present invention.

FIG. 19 is a schematic diagram of which (a) to (e) illustrate the positions of the guide unit in the sequence of machining processes in the main coordinate system and in the auxiliary coordinate system.

FIG. 20 is an illustrative diagram illustrating a wire electric discharge machine for use in a wire electric discharge machining method according to a second embodiment of the present invention.

FIG. 21 is an illustrative diagram illustrating a machining range of the wire electric discharge machine according to the second embodiment of the present invention.

FIG. 22 is an illustrative diagram illustrating a wire electric discharge machine for use in a wire electric discharge machining method according to a third embodiment of the present invention.

### DESCRIPTION OF EMBODIMENTS

Embodiments of a wire electric discharge machine, a guide unit, and a wire electric discharge machining method according to the present invention will be described in detail below with reference to the drawings. Note that the present invention is not necessarily limited to the specific embodiments described below, but rather, the embodiments may be modified as appropriate without departing from the spirit of the present invention. For purposes of ease of understanding, the drawings referenced below may illustrate each component on a different scale from the actual scale. A similar scaling policy applies to a case when figures are compared with each other. Even in a cross-sectional view, hatching lines may be omitted for clarity of illustration. In addition, even in a plan view, hatching lines may be used for clarity of illustration.

### First Embodiment

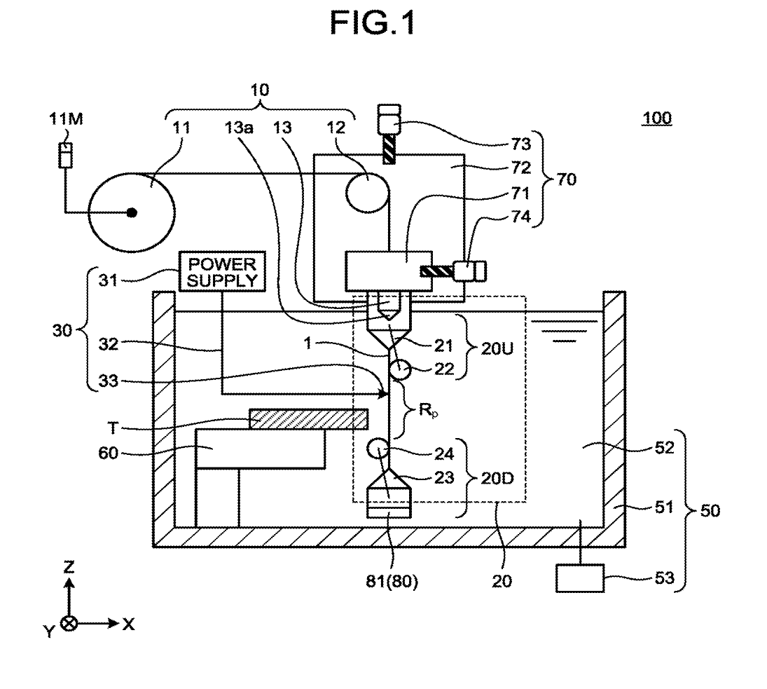

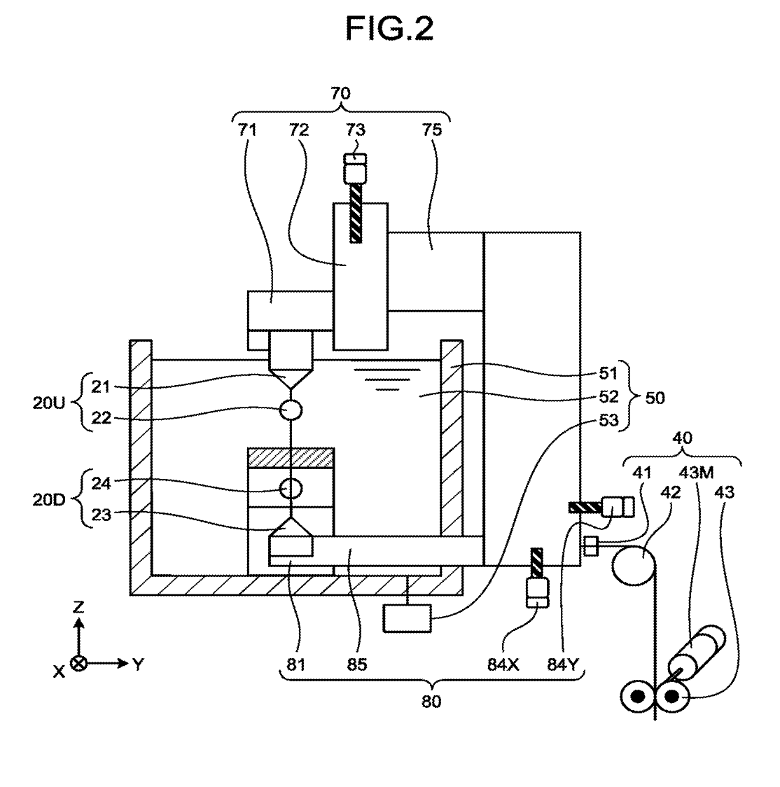

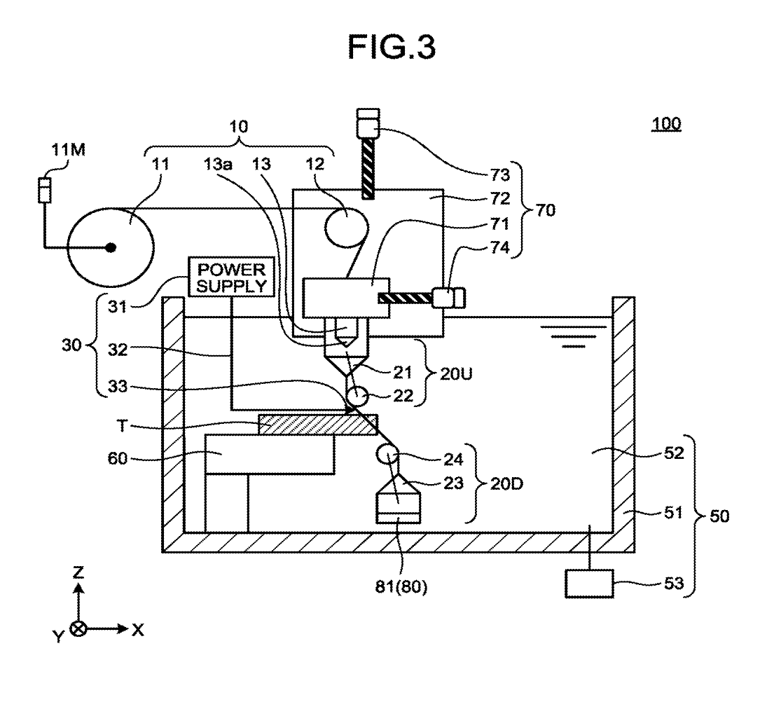

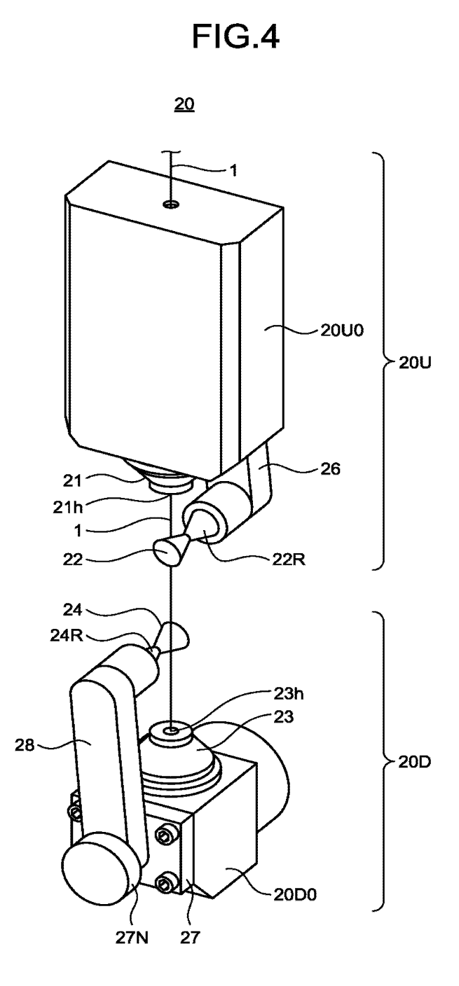

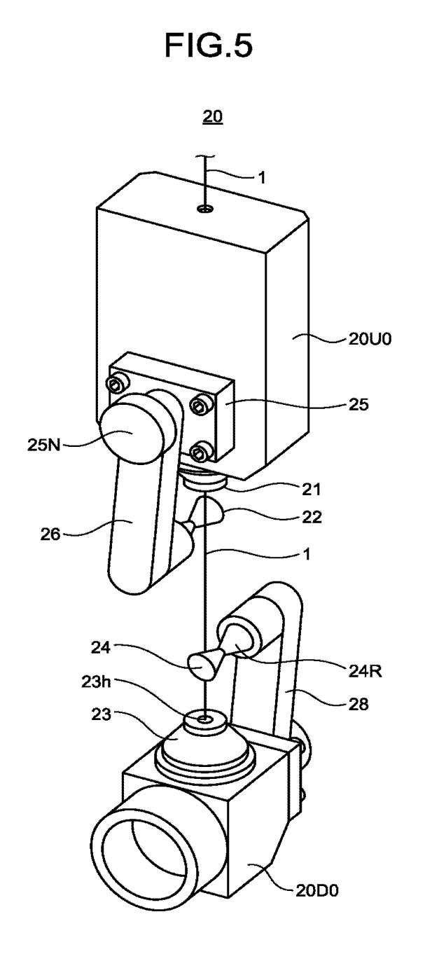

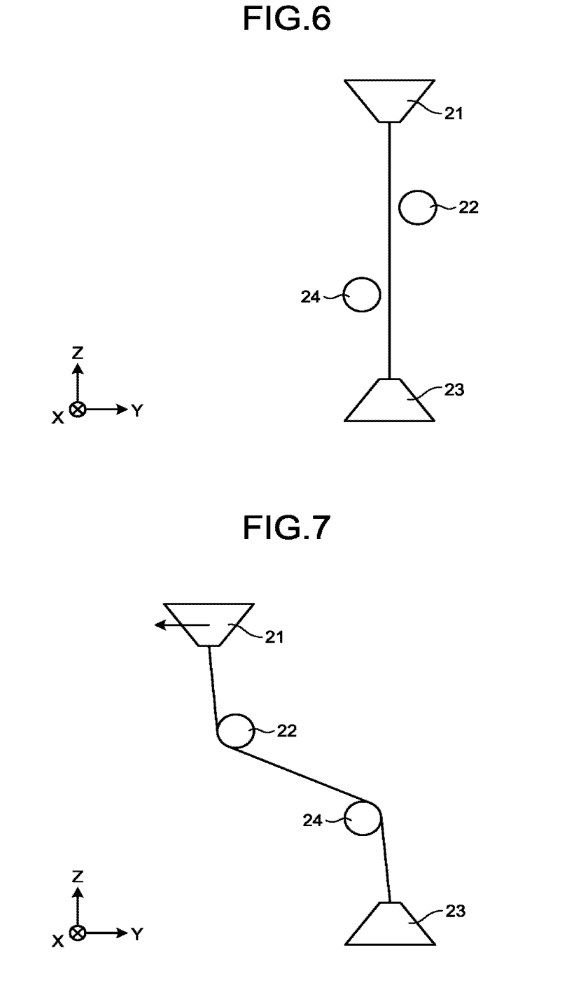

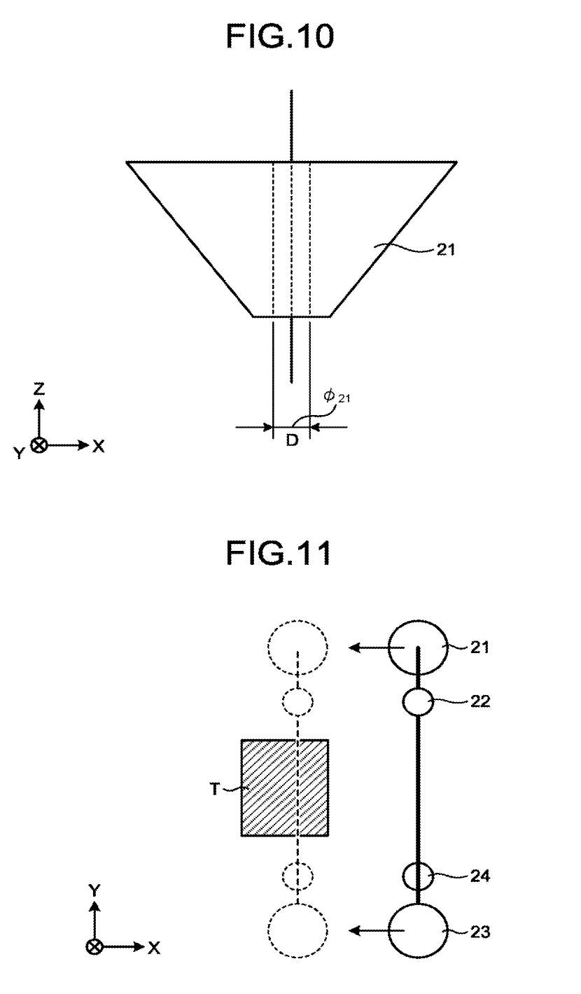

FIGS. 1 to 3 each schematically illustrate a wire electric discharge machine according to a first embodiment of the present invention. FIG. 1 is a front view, and FIG. 2 is a side view. FIG. 3 is a front view illustrating a state in which a wire electrode 1 is tilted. FIG. 4 is a perspective view of a guide unit of the wire electric discharge machine according to the first embodiment of the present invention as viewed from the front. FIG. 5 is a perspective view of that guide unit of the same as viewed from the rear. FIGS. 6 to 8 are each an illustrative diagram illustrating a concept of the wire electric discharge machine according to the first embodiment of the present invention. FIG. 9 is an illustrative diagram illustrating a positional relationship between a first support element 22 and a second support element 24. FIG. 10 is an enlarged illustrative view of a main portion of the first wire guide. As illustrated in FIGS. 1 to 3, a wire electric discharge machine 100 of the first embodiments is configured such that a wire guide unit consisting of a guide unit having two support points is added to a wire electric discharge machine that causes the wire electrode 1 to vertically move, thereby to make changeable the position and the direction of the wire electrode 1 under a condition in which a longitudinal or heavy workpiece T is fixed, and thus to machine the workpiece T while changing the machining direction.

The wire electric discharge machine 100 of the first embodiment includes: a supply unit 10 that supplies the wire electrode 1, a guide unit 20 serving as a wire guide part preparing the wire electrode I, which stretches the wire electrode i in motion supplied from the supply unit 10, and guides the wire electrode 1 to a machinable range section Rₚ where a workpiece T is situated; an electricity supply unit 30 that supplies electricity to the wire electrode 1; a collection unit 40 that collects the wire electrode 1 that has been used for machining; and a fluid tank unit 50 for supplying a machining fluid to the machinable range section Rₚ. The workpiece T is placed on a table surface plate that is a fixture jig 60.

The guide unit 20 includes: a first wire guide 21; a second wire guide 23 disposed spaced apart by a certain distance from the first wire guide 21; and a first support element 22 and a second support element 24 dispose between the first and second wire guides 21 and 23. The first support element 22 is disposed spaced apart by a first distance from the first wire guide 21 and defines a passage location of the wire electrode 1. The second support element 24 is disposed spaced apart by a second distance from the second wire guide 23 and defines another passage location of the wire electrode 1. The first support element 22 is movable relative to the first wire guide 21. Similarly, the second support element 24 is movable relative to the second wire guide 23. A line segment connecting the first and second support elements 22 and 24 is tiltably formed. The machinable range section Rₚ of the wire electrode 1 is formed by a part of the wire electrode 1 that is stretched between the first and second support elements 22 and 24. An extending direction of the wire electrode 1 can tilt relative to an extending direction of the wire electrode 1 supplied vertically from the supply unit 10 by the guide unit 20, and the direction of the wire electrode 1 can be changed in the process of driving of the electrode. The direction of the first support element 22 with respect to the first wire guide 21 can be defined by an angle between a line connecting a wire lead-out position of the first wire guide 21 on the first support element 22 side and the first support element 22, and a vertical line. The direction of the second support element 24 with respect to the second wire guide 23 can be defined by an angle between a line connecting a wire lead-out position of the second wire guide 23 on the second support element 24 side and the second support element 24, and a vertical line.

As illustrated in FIGS. 4 and 5, the first wire guide 21 is attached to a first unit body 20U0. The first support element 22 is attached to a first attachment plate 25 of the first unit body 20U0 via a first arm 26, while the direction of the first arm 26 can be changed. That is, the first wire guide 21 is fixed on the first unit body 20U0, and the first support element 22 is attached to the first arm 26 that is rotatably supported by the first unit body 20U0.

In addition, as illustrated in FIGS. 4 and 5, the second wire guide 23 is attached to a second unit body 20D0. The second support element 24 is attached to a second attachment plate 27 of the second unit body 20D0 via a second arm 28, and the direction of the second arm 28 can be changed. That is, the second wire guide 23 is fixed on the second unit body 2050, and the second support element 24 is attached to the second arm 28 that is rotatable supported by the second unit body 2050.

The first and second arms 26 and 28 may also be configured such that not only the directions thereof but also the lengths thereof can be changed. By changing the direction or the length of the first arm 26 or the second arm 26 in the process of machining, a machining angle or a machining area of the machinable range section Rₚ of the wire electrode 1 can be expanded to enable a desired machined shape to obtained in a wider sphere in one continuous operation.

The first wire guide 21 and the second wire guide 23 have their respective through-holes 21h and 23h that each allow the wire electrode 1 to be inserted therein in a direction in which the electrode 1 has been supplied to the holes circumferentially guide the wire electrode 1. The first support element 22 and the second support element 24 are formed by their respective first and second guide rollers 22R and 24R that each make contact with the wire electrode 1 supplied through the first wire guide 21 to define a passage location of the wire electrode 1.

The first support element 22 is fixed to the first attachment plate 25 of the first unit 20U via the first arm 26 using a first adjustment screw 25N. The first attachment plate 25 is disposed on the rear surface of the first unit body 20U0, and if the first support element 22 is not used, only the first attachment plate 2 spored on the first unit body 20U0. Thus, even when the wire electrode 1 is vertically stretched as is done usually without using a function of the guide unit 20, no problem particularly occurs in interference between the wire electrode 1 and the first support element 22.

Similarly, the second support element 24 is fixed to the second attachment plate 27 of the second unit 20D via the second arm 28 using a second adjustment screw 27N. The second attachment plate 27 is disposed on the rear surface of the second unit body 20D0, and if the second support element 24 is not used, only the second attachment plate 27 is disposed on the second unit body 2050. Thus, also for the second support element 24, even when the wire electrode 1 is vertically stretched as is done usually without using a function of the guide unit 20, no problem particularly occurs in interference between the wire electrode 1 and the second support element 24.

Adjustment of the first adjustment screw 25N relative to the first attachment plate 25 determines the direction of the first arm 26. On the other hand, adjustment of the second adjustment screw 27N relative to the second attachment plate 27 determines the direction of the second arm 28. The directions of the first arm 26 and the second arm 28 determine a horizontal inter-support-element distance L_{A} and a vertical inter-support-element distance L_{B} between the first and second support elements. However, the first arm 26 and the first unit 20U, and the second arm 28 and the second unit 20D may be previously integrated together, respectively.

The supply unit 10 allows the one-string wire electrode 1 reeled out from a wire supply reel 11 to pass through a wire tension control roller 12 into an automatic connection unit 13. The wire supply reel 11 is driven by a supply motor 11M.

The electricity supply unit 30 includes a power supply 31 for electric discharge machining, a feeder line 32, and a feed element 33 feeding electric power to the wire electrode 1.

The collection unit 40 includes a lower nozzle 41, a roller 42, and a wire electrode collection roller 43. The wire electrode collection roller 43 is driven by a collection motor 43M.

The fluid tank unit 50 fills a fluid tank 51 with machining fluid 52, and supplies the machining fluid 52 to the machinable range section Rₚ covering the wire electrode 1. The fluid tank 51 has a liquid level adjuster 53 at the bottom thereof to control supply and discharge of the machining fluid 52.

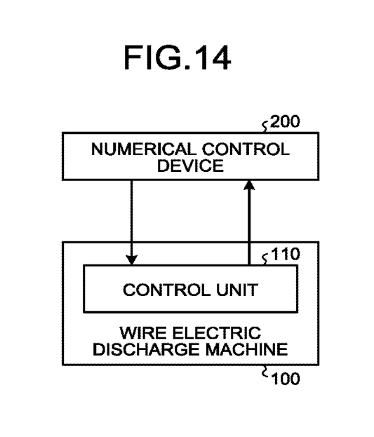

The first unit 20U is driven by a first drive system 70, and the second unit 20D is driven by a second drive system 60. The first and second units 20U and 20D can move independently of each other. The sequence of operations is performed, as illustrated in a hardware configuration of FIG. 14, by a control unit 110 of the wire electric discharge machine 100 executing control based on instructions from a numerical control device 200. The control unit 110 will be described later herein. In the wire electric discharge machine of the first embodiment, the first and second drive systems 70 and 80 are electric actuators. The first and second adjustment screws 25N and 27N are driven by the control unit 110 included in the wire electric discharge machine 100. The wire electric discharge machine 100 may be configured such that the first arm 26 and the second arm 26 are rotated to be out of the interference area of the machining range and retained in a retracted position when the wire electrode 1 is vertically stretched, while the first arm 20 and the second arm 28 are allowed to emerge in the passage location of the wire electrode 1 only when the position or direction of the wire electrode 1 needs to be changed.

As illustrated in FIG. 2, the first drive system 70 that drives the first unit 20U includes a first horizontal drive 71 that horizontally drives the first unit 20U, a first vertical drive 72 that vertically drives the first unit 20U, a first vertical drive motor 73, and a first horizontal drive motor 74. The first horizontal drive 71 and the first vertical drive 72 are supported by a first support rod 75 extending to an upper portion.

The second drive system 80 that drives the second unit 20D includes a second horizontal drive 81 that horizontally drives the second unit 20D, a second X-direction horizontal drive motor 84X, and a second Y-direction horizontal drive motor 84Y. The second horizontal drive 81 is supported by a second support extending horizontally.

The first and second units 206 and 20D can be driven independently of each other in horizontal and vertical directions. The first unit 20U is horizontally driven using the first horizontal drive motor 74 having bases of an X-axis motor and a Y-axis motor. The second unit 20D is horizontally driven using the second X-direction horizontal drive motor 94X consisting of an X-axis motor, and the second Y-direction horizontal drive motor 84Y consisting of a Y-axis motor. As used herein, the X-axis and the Y-axis of the first unit 206 are referred to as Xu-axis and Yu-axis, respectively, and the X-axis and the Y-axis of the second unit 20D are referred to as Xd-axis and Yd-axis, respectively. In addition, the first horizontal drive 71 is attached to the first vertical drive 72 to move along a Z-direction, and the first unit 20U can move horizontally and vertically by means of the control unit 110 described above.

In the configuration described above, machining can be provided while a relative position between the first wire guide 21 and the second wire guide 23 is maintained by defining the relative position in a second coordinate (i.e., auxiliary coordinate) using the Xu-axis and the Yu-axis, and defining the relative position in a first coordinate (i.e., main coordinate) using the Xd-axis and the Yd-axis. By setting Xd=0 mm to Xd=+30 ram and Yd=0 mm to Yd=0 mm in a machining program for Xu=+10 mm and Yu=0 mm, Xd shifts by +30 mm while the first wire guide 21 maintains the condition of Xu=+10 mm with the second wire guide 23. This enables the machining program to be relatively easily configured.

The first horizontal drive 71 is connected with the automatic connection unit 13, which is what is called an automatic wire connection device. When the wire electrode 1 is not yet provided between the first wire guide 21 and the second wire guide 23, the automatic connection unit 13 cooperates with the wire supply reel 11 to automatically supply the wire electrode 1 in response to an instruction from the control unit 110 to stretch the wire electrode 1 between the first wire guide 21 and the second wire guide 23. To efficiently carry out automatic stretch of the wire electrode 1, the automatic connection unit 13 may supply a machining fluid flow to the first wire guide 21 to generate a pillar of machining fluid between the first wire guide 21 and the second wire guide 23.

FIG. 3 illustrates an example in which the first wire guide 21 and the second wire guide 23 are placed in horizontally different positions relative to each other by their respective corresponding drives to machine the workpiece T in an inclined form. As illustrated in FIG. 3, such configuration enables the machining direction to be changed freely, and the machining range to be expanded. Upon breakage of the wire electrode during machining when the first wire guide 21 and the second wire guide 23 are situated in horizontally different positions relative to each other and the wire electrode 1 is stretched at a tilt angle as illustrated in FIG. 3, a conventional machining tool supplies the wire electrode 1 only vertically from the first wire guide 21 even when the automatic connection unit 13 is used, thereby failing to automatically stretch the wire electrode 1. In contrast, upon breakage of the wire electrode 1, the machine of the first embodiment can restore the first wire guide 21 and the second wire guide 23 to any vertically aligned positions, and after the automatic connection unit 13 performs automatic wire connection, restore the guides to the positions where the breakage has occurred. Note that the positions of the first and second wire guides 21 and 23 and the first and second support elements 22 and 24 of the guide unit 20 are stored by the control unit 110 at every necessary time. This enables the first and second wire guides 21 and 23 and the first and second support elements 22 and 24 to be automatically placed back to the positions before the breakage occurred.

The second horizontal drive 81 is configured such that the second support rod 85 having the second wire guide 23 disposed thereon protrudes from the fluid tank 51, and that the second support rod 85 and the fluid tank 51 are sealed together to prevent the machining fluid 52 from leaking out. The first support rod 75 having the first vertical drive 72 and the first horizontal drive 71 disposed thereon, and the second support rod 8.5 form together a U-shape. Driving of the second horizontal drive 81 causes the first support rod 75 and the second support rod 85 to move together. That is, a positioning instruction of the second horizontal drive 81 causes the first and second wire guides 21 and 23 to move while maintaining relative relationship with respect to each other.

The one string wire electrode 1 reeled out from the supply unit 10 having an automatic wire connection mechanism changes the moving direction by the guide unit 20, and at the same time the electrode is supplied electricity from the electricity supply unit 30 to provide electric discharge machining, and is automatically supplied until the electrode is collected by the collection unit 40. The sequence of operations is performed, as illustrated in a hardware configuration of FIG. 14, by the control unit 110 of the wire electric discharge machine 100 carrying out control based on instructions from the numerical control device 200. Note that positional information of the first and second wire guides 21 and 23 and the first and second support elements 22 and 24 of the guide unit 20 are stored at every necessary time in a storage unit provided in the control unit 110. Driving of the first and second drive systems 70 and 80 is controlled using the positional information stored in the storage unit.

The wire electric discharge machine 100 of the first embodiment moves the wire electrode 1 in a desired direction by the guide unit 20 to prepare the wire electrode 1, and supplies electricity to the wire electrode 1 from the power supply 31 for electric discharge machining via the feeder line 32 and the feed element 33 while operating the wire electrode to run. The feed element 33 causes the wire electrode 1 to approach the workpiece T and causes the wire electrode 1 to provide electric discharge machining of the workpiece T. Various kinds of wire electrode conductors may be used for the wire electrode 1, including a brass wire having a diameter of 0.1 mm to 0.3 mm. The workpiece T undergoes electric discharge machining in the machining fluid 52 similarly to a standard wire electric discharge machining. As illustrated in FIG. 14, a step for connection of the wire electrode 1 and various steps related to the connection, which are preparation steps up to actual machining, are performed by the control unit 110 of the wire electric discharge machine 100 based on instructions from the numerical control device 200.

The drive mechanism for each corresponding portion is not limited to that of the first drive system 70 and the second drive system 80 described above, and is realised by way of an X-axis head, a Y-axis head, and a 2-axis head which are movable along the X-axis, the Y-axis, and the 2-axis, respectively, but may use a standard drive element.

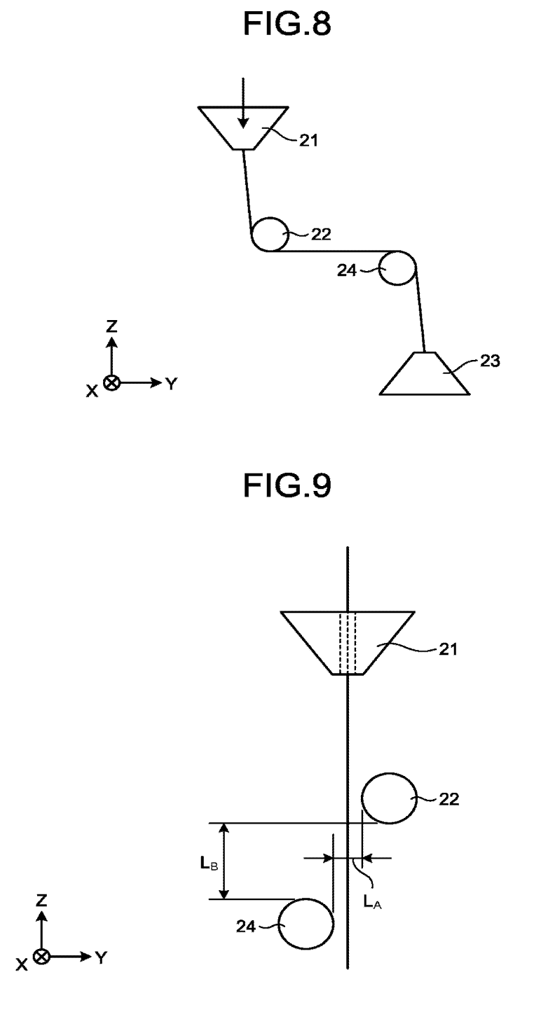

An operation of the wire electric discharge machine of the first embodiment will next be described. First, FIGS. 6 to 8 illustrate a basic operation of the wire electric discharge machine. FIG. 6 illustrates a state in which the guide unit 20 is allocated immediately below the supply unit 10 configured to move the wire electrode 1 vertically. FIG. 6 illustrates a state in which the wire electrode 1 is received from the supply unit 10 so that the wire electrode 1 passes from the first wire guide 21 through the second wire guide 23. In FIG. 6, the first support element 22 that cooperates with the first wire guide 21, and the second support element 24 that cooperates with the second wire guide 23 are not in contact with the wire electrode 1. Next, as illustrated in FIG. 7, when the first wire guide 21 or the second wire guide 23 moves in the X-direction or Y-direction, the wire electrode 1 is stretched between the first support element 22 and the second support element 24. Further, when the first wire guide 21 and the first support element 22 move downward, i.e., in a −Z direction, the angle of the wire electrode 1 stretched between the first support element 22 and the second support element 24 is changed as illustrated in FIG. 8. Although FIGS. 6 to 8 illustrate movement on the Y-Z plane for simplicity of illustration, a similar description also applies to movement on the X-Y-Z plane obviously.

A combination of the operations of FIGS. 7 and 8 enables the wire electrode 1 to be freely changed in various directions.

Allocation of the first support element 22 and the second support element 24 during operation will be described. FIG. 9 is an illustrative diagram illustrating a positional relationship between the first support element 22 and the second support element 24. FIG. 10 is an enlarged illustrative view of a main portion of the first wire guide. The first wire guide 21 internally has a cylindrical hole having a hole diameter ϕ₂₁=D. The first support element 22 and the second support element 24 are spaced apart from each other by a horizontal inter-support-element distance L_{A}. The horizontal inter-support-element distance L_{A} is greater than or equal to the hole diameter of the through-hole 21h or 23h of the first wire guide 21 and the second wire guide 23. If the hole diameters ϕ₂₁ and ϕ₂₃ (not illustrated) of the through-hole 21h of the first wire guide 21 and the through-hole 23h of the second wire guide 23 are equal to each other, the horizontal inter-support-element distance L_{A} is set to a value greater than 0 mm.

Allocation of the first support element 22 and the second support element 24 to provide a sufficient horizontal inter-support-element distance L_{A} is also advantageous in using a so-called automatic wire connection function that is one of functions realized by the wire electric discharge machine 100, in which the wire electrode 1 supplied from the first wire guide 21 positioned in an upper portion is automatically supplied to the second wire guide 23 positioned in a lower portion. In other words, the first support element 22 and the second support element 24 do not exist in the supply path of the wire electrode 1, thereby the automatic wire connection function working effectively. Since the first support element 22 and the second support element 24 are not situated in the supply path of the wire electrode 1, there is no obstruction when the automatic connection unit 13 of the supply unit 10 uses the automatic wire connection function to inject a machining liquid column with a high speed flow of the machining fluid 52. Note that, to prevent interference with the first support element 22 or the second support element 24 when the first wire guide 21 and the first support element 22, or the second wire guide 23 and the second support element 24 move, the vertical inter-support-element distance L_{B} is set to at least greater than 0 mm, in this example, about 2 mm. Thus, to prevent interference between the first support element 22 and the second support element 24 from occurring, the wire electric discharge machine 100 having the guide unit 20 attached thereto preliminarily stores positional information including the horizontal inter-support-element distance L_{A} and the vertical inter-support-element distance L_{B} between the first support element 22 and the second support element 24 in the control unit 110 in the wire electric discharge machine 100, and outputs an instruction to stop the movement before reaching a position of the possible interference.

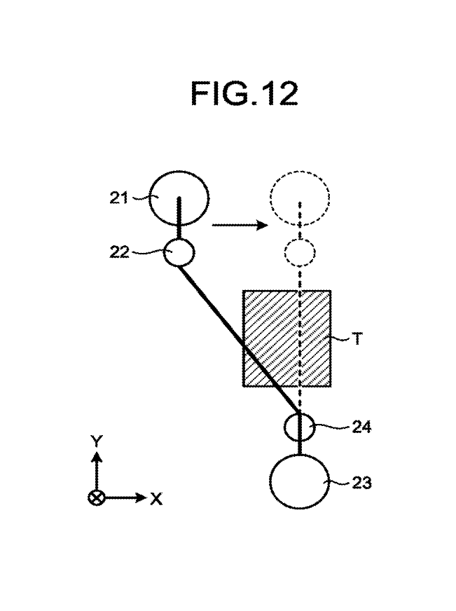

A method for driving the guide unit in the machining process that uses the wire electric discharge machine of the first embodiment will next be described in detail. Prior to description thereof, a basic concept of the machining method is described. FIGS. 11 and 12 illustrate two basic machining methods that use the wire electric discharge machine of the first embodiment. FIG. 11 illustrates a machining process using the first and second units 20U and 20D in the main coordinate system. A machining process in the main coordinate system has a step of the stretched wire electrode machining the workpiece T in accordance with a movement instruction to the second horizontal drive 81. Since the first horizontal drive 71 is placed above the second horizontal drive 81, machining can be realized in a condition in which the wire electrode 1 maintains a certain machinable range section Rₚ, in accordance with an instruction to the main coordinate system carrying coordinates for control of the second horizontal drive 81.

FIG. 12 is an explanatory diagram illustrating a machining process in the auxiliary coordinate system in which only the first unit 20U is driven. In a machining process in the auxiliary coordinate system, the second horizontal drive 81 is not driven during machining, but only the first horizontal drive 71 which moves the first unit 20U is driven during the same. Only the first wire guide 21 and the first support element 22 are driven relative to the stretched wire electrode 1 and the workpiece T is machined under a condition in which the machinable range section Rₚ is fixed or changed within any desired range. Since the first horizontal drive 71 is placed above the second horizontal drive 81, it is possible to perform machining while the wire electrode 1 makes the machinable range section Rₚ unchanged, or makes it changed within any desired range, in accordance with an instruction to the auxiliary coordinate system carrying the coordinates for control of the first horizontal drive 71. Since the second horizontal drive 81 is stationary relative to the workpiece T, the workpiece T can be machined to have a sloping surface. Alternatively, when the second horizontal drive 81 is in a driving condition, the first horizontal drive 71 is driven to be stationary relative to the workpiece T, thereby making it possible to form a sloping surface in opposition.

In both cases of machining in the main coordinate system and machining in the auxiliary coordinate system, the positions in the Z-direction of the first wire guide 21 and the first support element 22 do not need to be fixed, but a positional instruction of Z-direction may also be provided to the first wire guide 21 and the first support element 22 depending on the machining shape or machining trajectory with no problem.

In addition, in both types of machining, when the wire electrode 1 is broken, the firs and second units 20U and 20D are caused to be returned to the initial positions illustrated in FIG. 6 and automatic connection is performed. That is, the first and second units 20U and 20D are temporarily returned to their initial positions whose positional information has been previously stored in the control unit 110 of the wire electric discharge machine 100, and after the wire electrode 1 is stretched by the automatic connecting operation, the machining is restarted. In this process, since the positional information is stored in the control unit 110, the first and second units 20U and 202 are returned to the interruption positions, and the wire electrode 1 to be returned to the interruption position. As described above, the wire electric discharge machine 100 of the first embodiment has a machining restart function of returning the wire electrode 1 to the machining position after interruption due to breakage of the wire electrode 1, and then restarting machining.

FIGS. 11 and 12 illustrate examples in which the first support element 22 is situated in the +Y direction with respect to the first wire guide 21, and the second support element 24 is situated in the −Y direction with respect to the second wire guide 23. The present invention is not limited to the examples of FIGS. 11 and 12, and it is indisputable that any modification can be made as appropriate since both machining in the main coordinate system and machining in the auxiliary coordinate system can be provided as long as the basic concept described with reference to FIGS. 6 to 8 is maintained, under which the first support element 22 is situated in the +X direction with respect to the first wire guide 21, and the second support element 24 is situated in the −X direction with respect to the second wire guide 23.

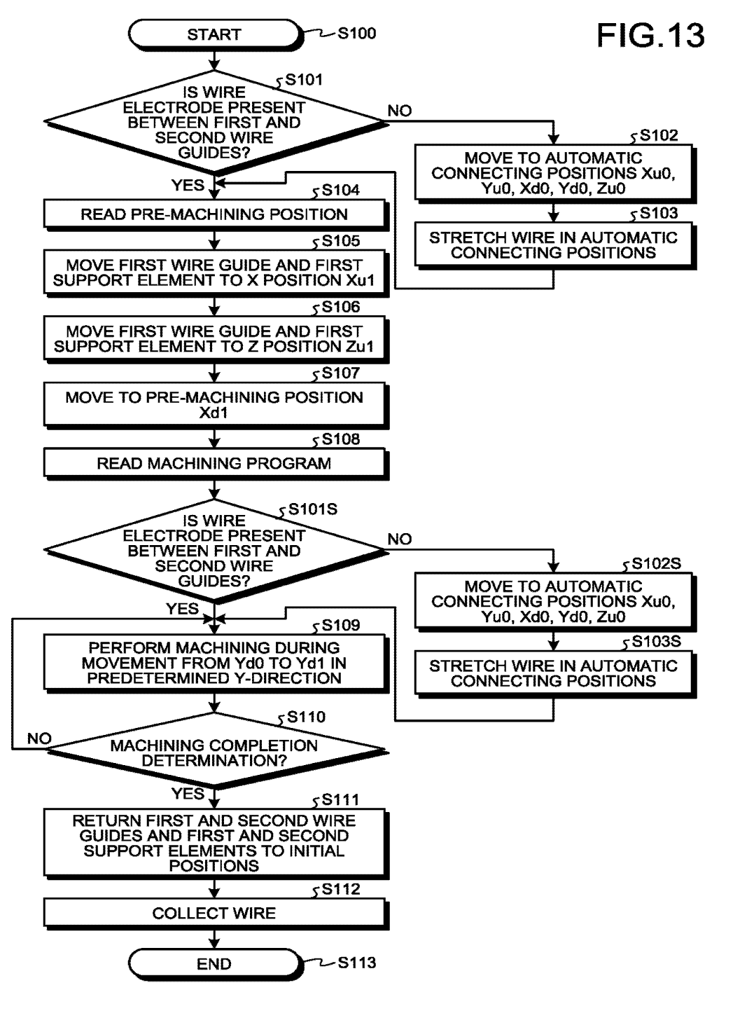

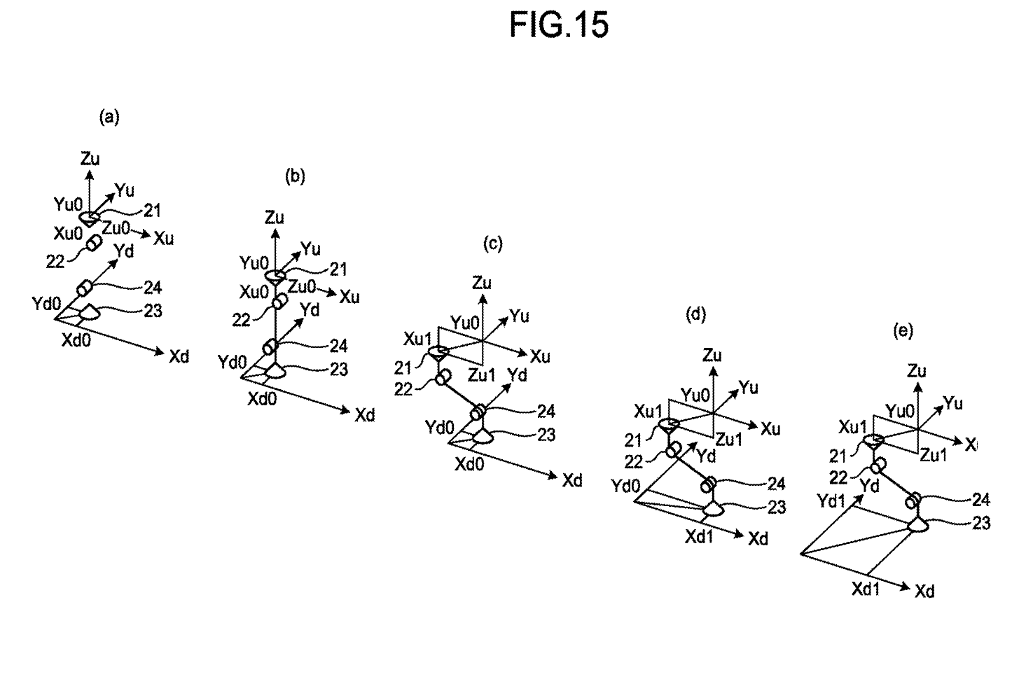

A wire electric discharge machining method using the wire electric discharge machine of the first embodiment will next be described using the flowchart of FIG. 13. As illustrated in FIG. 14, the sequence of operations is performed by the control unit 110 of the wire electric discharge machine 100 in accordance with instructions from the numerical control device 200. In FIG. 15, its parts (a) to (e) are each a schematic diagram illustrating the position of the guide unit 20 in the sequence of steps, wherein only the first and second wire guides 21 and 23, the first and second support elements 22 and 24, and the workpiece T are illustrated, and the other elements are omitted. First, description is given for an operation to connect the wire electrode 1 by the supply unit 10, that is a preliminary operation for controlling the moving direction of the wire electrode 1 relative to the guide unit 20.

First, starting step S100 is performed. Step S101 is then performed, in which it is determined whether or not the wire electrode 1 is present between the first and second wire guides 21 and 23. If the wire electrode 1 is not present between the first and second wire guides 21 and 23 and it is thus determined that the step S101's answer is No, the first and second units 20U and 202 are moved to be in automatic connecting positions of Xu0, Yu0, Xd0, Yd0, Zu0 at step S102 as illustrated in FIG. 15(a). In FIGS. 1 and 2, the wire electrode 1 supplied from the wire supply reel 11 constituting the supply unit 10 is continuously reeled out through the wire tension control roller 12 and fed to the automatic connection unit 13. The supply unit 10 uses the function of the automatic connection unit 13 to supply the wire electrode 1 through the first wire guide 21 toward the second wire guide 23 along the machining fluid flow ejected from an upper nozzle 13a of the automatic connection unit 13. During the supply process, the control unit 110 performs position adjustment according to the previously-stored program so that the wire electrode 1 is supplied through the first wire guide 21 and the second wire guide 23 to the collection unit 40, thereby to finely adjust the positions of the first and second units 20U and 20D. Note that the wire electrode 1 fed into the collection unit 40 is directed through the lower nozzle 41 and the roller 42 to the wire electrode collection roller 43.

If the first support element 22 and the second support element 24 are present on the supply path of the wire connection 1 when the wire electrode 1 is supplied and fed out, the control unit 110 evacuates the first support element 22 and the second support element 24 from the supply path. That is, in the supply process of the wire electrode 1, the first support element 22 and the second support element 24 are moved away from the supply path before starting of the supply of the wire using a machining fluid flow. This is intended to prevent the machining fluid flow from colliding with the first and second support elements 22 and 24, and to thus prevent instability or disturbance of the supply operation of the wire electrode 1.

Next, the control unit 110 uses the automatic connection unit 13 to pass the wire electrode 1 through the first wire guide 21, and insert the wire electrode 1 into the second wire guide 23. At step S103, in which the wire electrode 1 is stretched between the automatic connecting positions, the wire electrode 1 is inserted into the second wire guide 23 by the machining fluid flow as illustrated in FIG. 15(b).

When e wire electrode 1 has reached the second wire guide 23 by the machining fluid flow, the wire electrode supply operation using the machining fluid flow from the upper nozzle 13a is stopped, and then the first and second support elements 22 and 24 of the guide unit 20 that have been evacuated are returned to the initial positions. This is the initial state illustrated in FIG. 6 and in FIG. 15(b), in which the wire electrode 1 is stretched between the first wire guide 21 and the second wire guide 23.

At step S104 in which a pre-machining position is read, the control unit 110 stores the pre-machining position. Alternatively, pre-machining position information may be outputted from the control unit 110 to the numerical control device 200 to be stored therein.

The machining direction and the machining speed are determined based on the numerical data received from the numerical control device 200, and the positions of the first support element 22 and the second support element 24 are set to desired positions.

At step S105, the first wire guide 1 and the first support element 22 are moved to a position Xu1 as an X position.

At step S106, the first wire guide 21 and the first support element 22 are moved to a position Zu1 as a position. By way of step S105 and step S106, the first wire guide 21 and the first support element 22 are moved to the positions illustrated in FIG. 15(c).

At step S107, as illustrated in FIG. 15(d), the second wire guide 23 and the second support element 24 are moved to a position of Xd1, Yd0 as a pre-machining position. Since Yd0 has the same coordinate as the automatic connection position, the second wire guide 23 and the second support element 24 are moved to Xd1 along the X-axis, but are not moved along the Y-axis. In addition, since the movement in this case is based on the main coordinate system, the first wire guide 22 and the first support element 22 are moved by the same distance and in the same direction as those of the second wire guide 23 and the second support element 24.

At step S108, the machining program is read. In this process, the machining program provides electric discharge machining conditions, positional information, and so on to the numerical control device 200, and stores, in the program, positional information and speed instruction information on two or more steps to thereby control the drive axes so as to get a desired shape based on moment-to-moment variation of motor control. Because the shape is not a subject of discussion herein, a phrase such as “Yd1 to Yd2” specifies only a start point and an end point, and points Yd1n and Yd1n+1 along the way at every moment are omitted.

At machining step S109, the first unit 20U and the second unit 20D are operated at the machining speed based on the numerical data received from the numerical control device 200, and electricity is supplied to the wire electrode 1 by the electricity supply unit 30 while the movement from Yd0 to Yd1 is performed as illustrated in FIG. 15(e), so as to provide electric discharge machining. Machining methods used in this step include: a machining method in the main coordinate system by which machining is performed while the first and second units 20U and 20D maintain a certain machinable range section Rₚ; a machining method in the auxiliary coordinate system by which machining is performed while one unit is fixed and the other unit is moved with a constant machinable range section Rₚ or a variable machinable range section Rₚ having any amount of change; or a machining method using these machining methods in combination. For the machining step S109, a machining method in the main coordinate system illustrated in FIG. 11 is used.

En route to machining step S109, step S101S is performed every certain time period, in which it is determined whether or not the wire electrode 1 is present between the first and second wire guides 21 and 23. If the wire electrode is not present between the first and second wire guides 21 and 23, and it is thus determined that the step S101S's answer is No, the first and second units 20U and 205 are moved to come in the automatic connection positions of Xu0, Yu0, Xd0, Yd0, Zu0 at step S102S, and then step S103S is carried out, in which the wire electrode 1 is stretched in the automatic connecting positions. Steps S101S, S102S, and S103S are much the same as the previously-described steps S101, S102, and S103, and so a detailed description therefor is omitted here. When the wire electrode 1 is stretched, the first and second units 20U and 20D are returned to the positions immediately before the wire electrode is broken, based on the positional information stored in the control unit 110, and then the machining is continued.

After completion of machining step S109, it is determined whether or not machining has been completed at machining completion determination step S110. If No, the process returns to the machining step S109. Otherwise, if Yes at the machining completion determination step 5110, then step S111 is carried out in which the first support element 22 and the second support element 24 are returned to the initial positions.

After the first wire guide 21, the first support element 22, the second wire guide 23, and the second support element 24 are returned to the initial positions at step S111, the process enters step S112 to collect the wire electrode 1.

At collection step S112, the wire electrode 1 is firstly cut using the automatic connection unit 13, and the lower part, resulting from the cutting, of the wire electrode 1 is collected by the wire electrode collecting roller 43 rotated by the collection motor 43M.

The wire electric discharge machine 100 of the first embodiment can drive the first unit 20U and the second unit 20D independently, and perform electric discharge machining while the direction of the wire electrode 1 is tilted with respect to the wire electrode 1 supplied from the supply unit 10, and thereby the machining direction can be freely selected. In addition, a process of performing machining while the direction is changed can be continuously carried out. Moreover, the wire electrode 1 can be automatically connected besides, by virtue of capability to automatically stretch the wire electrode 1, it is possible to change the machining direction and broaden or narrow the machining range without disturbing continuous automatic operation. That is, the wire electrode connection step, the machining step, and the wire electrode collection step can be performed consecutively on the basis of the control of the control unit 110.

The wire electric discharge machine 100 of the first embodiment also enables the wire electrode 1 to return to the original machining position after automatic connection even if the wire electrode 1 once undergoes breakage.

In addition, in the wire electric discharge machine 100 that causes the wire electrode 1 to move vertically, use of the guide unit 20 having a pair of support elements disposed on upper and lower portions enables the wire electrode 1 to move horizontally, and thereby the machinable range is expanded.

The wire electric discharge machine 100 of the first embodiment enables the machining direction to be selected as is desired only by movement of the guide unit 20 even when the workplace T is machined while being fixed on the fixture jig 60 composed of a table surface plate. Thus, a long or heavy workpiece can be machined. Furthermore, in the case where the workpiece T has a portion that should not be dipped in the machining fluid for purposes of rust prevention or corrosion prevention, by setting the machining fluid level of the machining fluid 52 at or below a plane covered by the wire electrode that currently moves, machining can be performed without dipping the workpiece T in the machining fluid 52 thus to protect the workpiece T.

Although the wire electric discharge machine 100 of the first embodiment is configured such that the guide unit 20 is removable and is thus easy to handle, it is indisputable that the guide unit 20 may be integrated with a main body of the wire electric discharge machine. Although the first and second units 20U and 20D are movable independently, and the first and second wire guides 21 and 23 are also movable independently, it suffices that one of the two be movable and movable relative to the other. In addition, from a perspective of increasing the flexibility of a tilt angle of the machinable range section Rₚ, it is preferable that the first support element 22 is movable relative to the first wire guide 21 and the second support element 24 is movable relative to the second wire guide 23, but the support element may be immovable relative to the wire guide. Also from a perspective of automatic connection of the wire electrode 1, it is desirable that the first support element 22 is movable relative to the first wire guide 21 and the second support element 24 is movable relative to the second wire guide 23 for easy escape of the first support element 22 and the second support element 24 from the supply path. Note that in a case where the first support element 22 is not movable relative to the first wire guide 21, and the second support element 24 is not movable relative to the second wire guide 23, it suffices that the first support element 22 and the second support element 24 be situated in a position away from the supply path, that is, a position in which the horizontal inter-support-element distance L_{A} illustrated in FIG. 9 is ensured under a condition In which the first wire guide 21 and the second wire guide 23 are situated in their positions where the wire electrode 1 can be automatically connected.

The guide unit 20 used in the wire electric discharge machine 100 of the first embodiment is used by being attached to the first drive system 70 illustrated in FIG. 1. In actuality, the attachment of the guide unit 20 is realized by a fixture portion (not illustrated) provided in the first unit 20U illustrated in FIGS. 4 and 5, having the first wire guide 21 aligned with the automatic connection unit 13. That is, the guide unit 20 is advantageous in that the unit 20 is usable with the unit 20 being attached to an existing wire electric discharge machine, and also easy to handle.

Note that the flowchart illustrated in FIG. 13 illustrates an example of machining in the Y-direction. Exchange of the Y-component for an X-component and exchange of the X-component for a Y-component enable machining to be performed in the X-direction. In addition, decomposition of the Y-component into an X-component and a Y-component and decomposition of the X-component into a Y-component and an X-component can yield machining while moving the first and second units 20U and 20D at a tilt angle as viewed from the top with a certain machinable range section Rₚ being ensured.

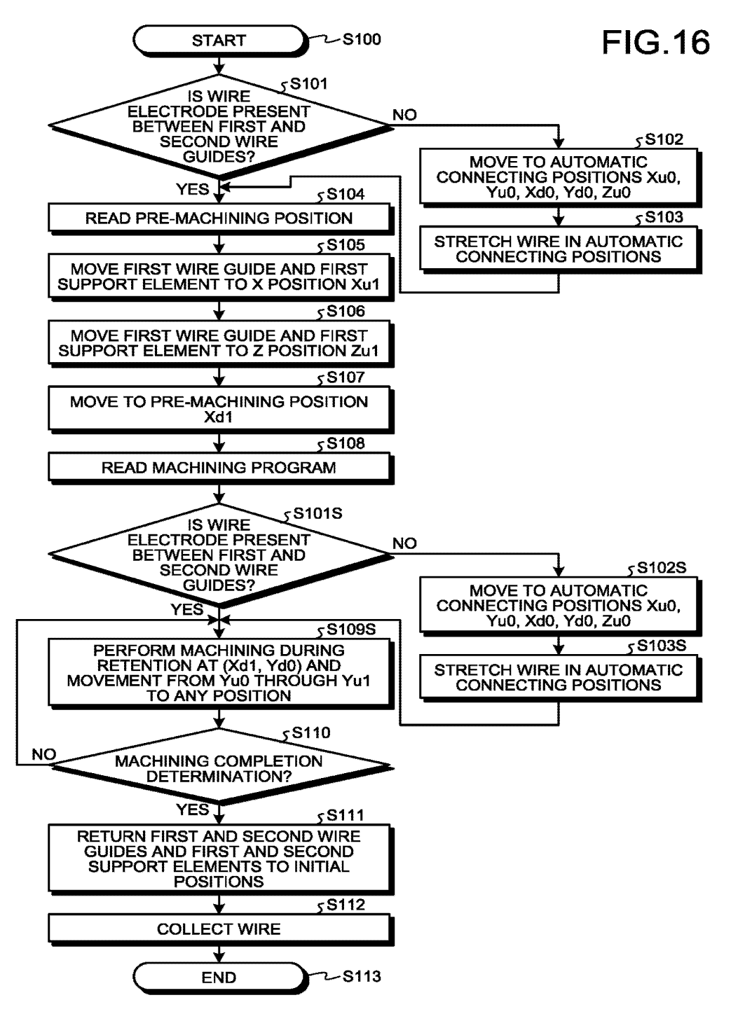

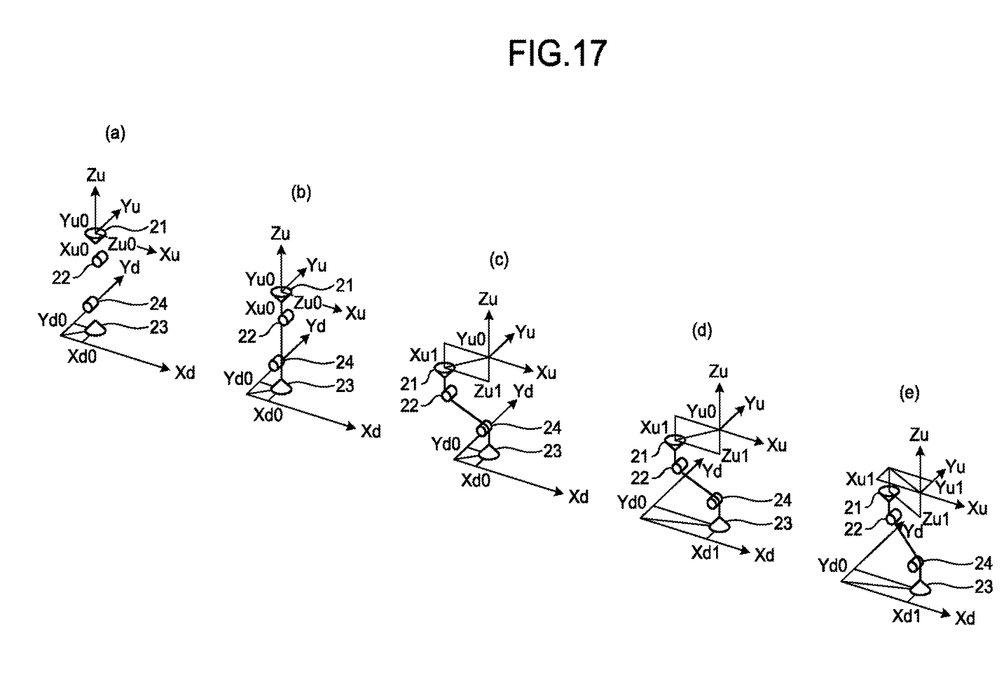

In the wire electric discharge machining method illustrated in FIGS. 13 and 15, description is given for an example of machining in the main coordinate system, in which machining is performed while the first and second units 20U and 20D maintain a certain machinable range section Rₚ. However, as illustrated in the flowchart in FIG. 16 and in the schematic diagrams in FIG. 17, (a) to (e) illustrating the positions of the guide unit 20 in a sequence of steps, machining may be performed using machining method in the auxiliary coordinate system illustrated in PIG. 12. The sequence of operations is performed, similarly to the wire electric discharge machining method illustrated in FIGS. 13 and 15, by the control unit 110 of the wire electric discharge machine 100, as illustrated in FIG. 16, in accordance with instructions from the numerical control device 200. Parts (a) to of FIG. 17 are each a schematic diagram illustrating the positions of the guide unit 20 in a sequence of steps, wherein only the first and second wire guides 21 and 23, and the first and second support elements 22 and 24 are represented and the other members are omitted.

In the case of machining in the auxiliary coordinate system, as illustrated in FIG. 16 and in FIG. 17, (a) to (e), the sequence of steps is similar to that in the case of machining in the main coordinate system except for machining step S109S. At machining step S109S, the second unit 20D stays in Xd1 and Yd0 while only the first unit. 20U is moved from Yu0 to Yu1 toward any desired position, so as to make machining.

Note that the flowchart illustrated in FIG. 16 illustrates an example of machining in the Y-direction, wherein exchange of the Y-component for an X-component and exchange of the X-component for a Y-component enable machining to be performed in the X-direction. In addition, it is possible that only the first unit 20U is moved in both X-direction and 1-direction so as to perform machining.

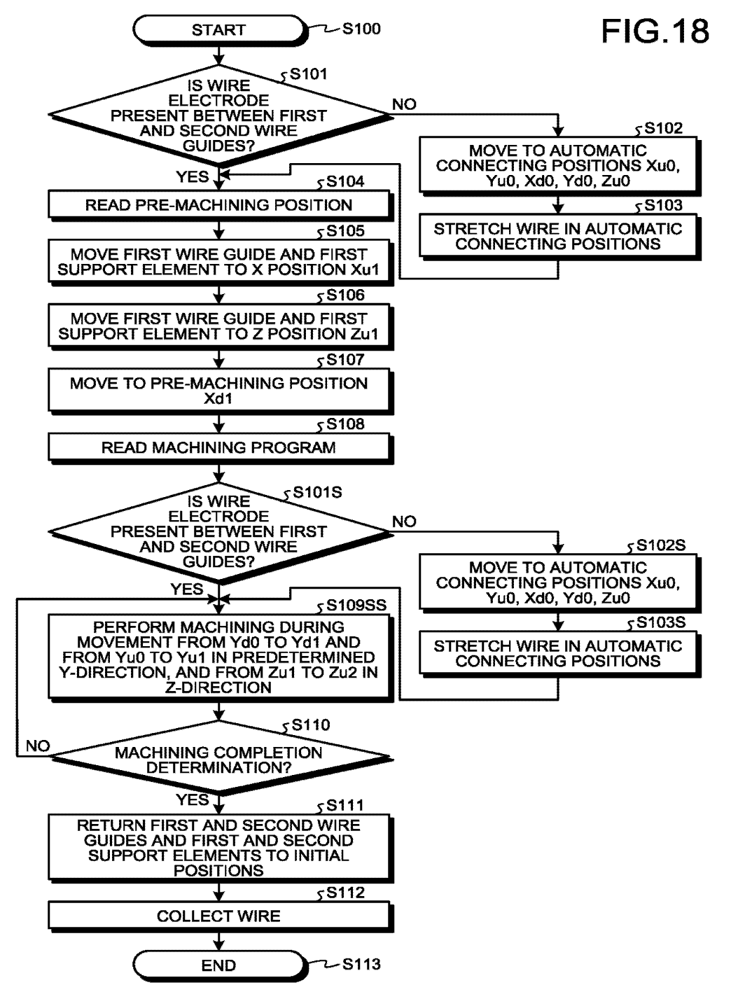

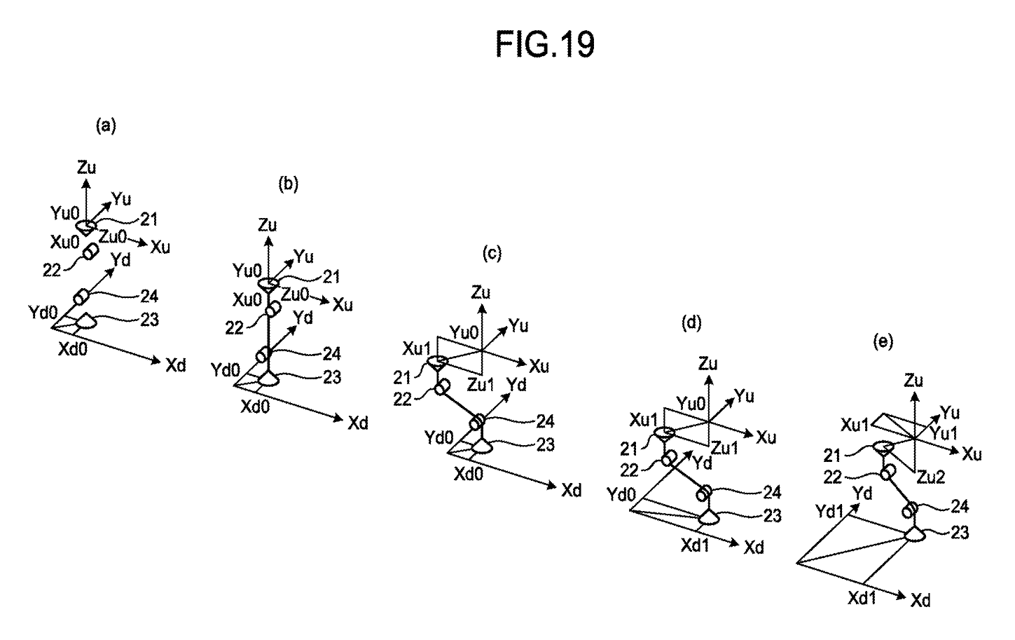

Moreover, as illustrated in the flowchart in FIG. 18 and in the schematic diagrams in FIG. 19, (a) to (e) illustrating the positions of the guide unit 20 in a sequence of steps, the driving operation in the main coordinate system of FIG. 11 and the driving operation in the auxiliary coordinate system of FIG. 12 be combined to perform machining along a tilt direction. The sequence of operations is performed, similarly to the wire electric discharge machining method illustrated in FIGS. 13 and 15, by the control unit 110 of the wire electric discharge machine 100 illustrated in FIG. 14, in accordance with instructions from the numerical control device 200. Parts (a) to (e) of FIG. 19 are each a schematic diagram illustrating the positions of the guide unit 20 in the sequence of steps, wherein only the first and second wire guides 21 and 23, the first and second support elements 22 and 24, and the workpiece T are represented, and the other elements are omitted.

In the case of machining in both the main coordinate system and the auxiliary coordinate system, as illustrated in FIG. 18 and in FIG. 19, (a) to (e), the sequence of steps is basically the same as each of the case of machining in the main coordinate system and the case of machining in the auxiliary coordinate system except for machining step S109SS. At machining step S109SS, the first unit 20U and the second unit 20D are both moved with shift in the Y-direction in the main coordinate system from Yd0 to Yd1, in the Y-direction in the auxiliary coordinate system from Yu0 to Yu1, and in the Z-direction from Zu1 to Zu2, so as to perform machining.

Note at the flowchart illustrated in FIG. 18 illustrates an example of machining in the Y-direction, wherein exchange of the Y-component for an X-component and exchange of the X-component for a Y-component enable machining to be performed in the X-direction. In addition, decomposition of the Y-component into an X-component and a Y-component and decomposition of the X-component into a component and an X-component make it possible that the first and second units 20U and 20D are caused to move at a tilt angle as viewed from the top to perform machining, or that the units 20U and 20D are caused to move in both X- and Y-directions to perform machining.

### Second Embodiment

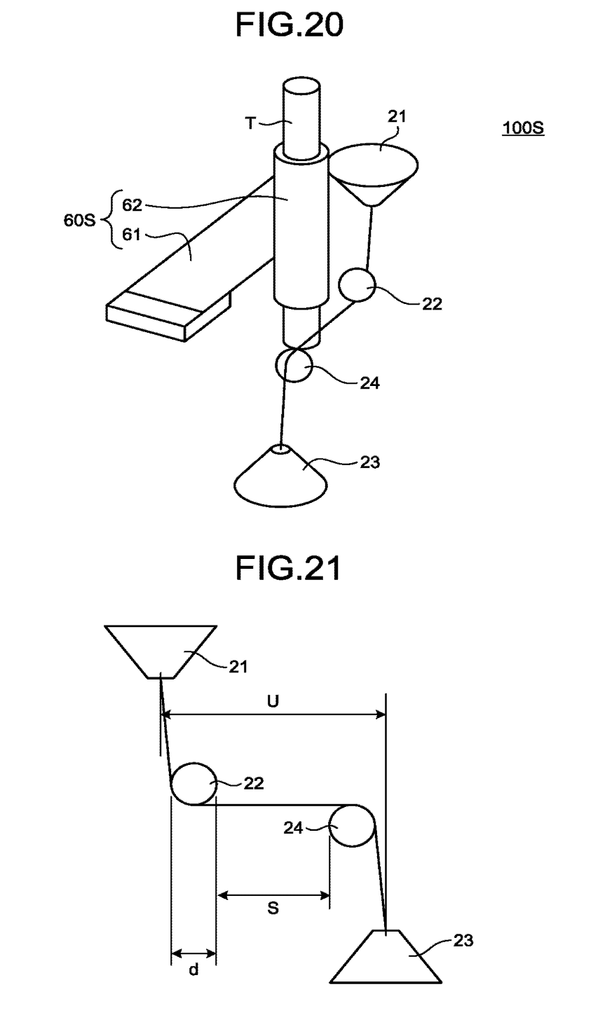

FIG. 20 is an illustrative diagram illustrating a wire electric discharge machine for use in a wire electric discharge machining method according to a second embodiment of the present invention. FIG. 21 is an illustrative diagram illustrating a machining range of the wire electric discharge machine according to the second embodiment. A wire electric discharge machine 100S of the second embodiment is characterized by its method of fixing the workpiece T, and its device configuration including the guide unit is similar to that of the wire electric discharge machine 100 of the first embodiment. The wire electric discharge machine 100S of the second embodiment is configured such that a wire electric discharge machine that causes the wire electrode 1 to move vertically is provided additionally with the guide unit 20 having two support points for the machine, thereby to set the wire electrode 1 in the horizontal direction, and make changeable the position and direction of the wire electrode 1 while a long workpiece T is fixed by a gripper 62 of a fixture jig 60S with a longitudinal direction of the workpiece T being kept in the vertical direction, thus to perform electric discharge machining of the workpiece T while the machining direction is changed.

The wire electric discharge machine 100S of the second embodiment holds the workpiece I using the fixture jig 60S designed for fixing a long object. The fixture jig 60S is composed of a main body 61 and the gripper 62 that has a cylindrical shape, protrudes from the main body 61, and is formed to circumferentially surround a cylindrical body of a target object.

Similarly to what is illustrated in FIG. 8 in the first embodiment, the wire electrode 1 is stretched almost horizontally, and machining is performed in the main coordinate system in a state in which the first and second units 20U and 20D maintain a certain machinable range section R as illustrated in FIG. 11.

The wire electric discharge machining method of the second embodiment enables machining of an edge portion up to 30 mm even when a long object having a diameter of 30 mm and a length of 800 mm is used as the workpiece T.

In this operation, assuming that, as illustrated in FIG. 21, the relative travel distance between the first and second wire guides 21 and 23 is represented by U, and inter-support distances of the first support element 22 and the second support element 24 are, for example, equal to each other, and represented by d, respectively, the maximum machining range S in the plane in the radial direction of the workpiece T can be calculated by S=U−2d−L_{A}, where the horizontal inter-support-element distance is represented by L_{A}.

In the circumstances, a usual wire electric discharge machine requires the workpiece to have dimensions smaller than the dimensions in all the depth, width, and height directions of the fluid tank that serves as a machining chamber to allow the workpiece to fall inside the fluid tank, and moreover, requires a machined portion of the workpiece to be positioned within the movable range of the wire electrode. A wire electric discharge machine having a workpiece maximum dimension of 800 mm in depth, 700 mm in width and 200 mm in height, an X-axis travel distance of 400 mm, and a Y-axis travel distance of 300 mm will have a machining range of ±200 mm from the center of the workpiece depending on the X-axis travel distance even if the workplace maximum dimension is 800 mm or less. In a case of machining a long workpiece, the user may want to machine an edge portion up to 30 mm for the workpiece having a diameter of 30 mm and length of 800 mm. In such a case, even for a machining range of ϕ30-30 mm, a user has to use a wire electric discharge machine of a type having a workpiece maximum dimension of 1250 mm in depth, 1000 mm in width, and 300 mm in height, an X-axis travel distance of 800 mm, and a Y-axis travel distance 600 mm.

Note that a wire electric discharge machine that vertically stretches the wire electrode for machining usually supplies a machining fluid from the wire guide at some flow rate or at some pressure during machining so as to improve machining performance. In contrast, in the wire electric discharge machine 100S of the second embodiment, the first and second wire guides 21 and 23 are not in a straight line with each other, and so supply of the machining fluid 52 during machining has little effect of improving machining performance. Therefore, when the machining is performed in a state other than an initial state in which the wire electrode 1 is extended vertically, the wire electric discharge machines 100 and 10 of the first and second embodiments may cause the control unit 110 of the wire electric discharge machine 100 to inactivate supplying of the machining fluid automatically or on a case-by-case basis.

However, particularly in the second wire guide 23, because cutting chips wafted in machining can enter the guide, and further enter through-hole 23h for the wire electrode 1 and the second wire guide 23, so-called guide clogging can be caused by which the machining process is stagnated, or breakage of the wire electrode 1 may be caused. For this reason, machining fluid supply from the second wire guide 23 may be activated automatically or on a case-by-case basis. Similarly, in order to prevent cutting chips from staying around the machined portion, supply of machining fluid from the first or second wire guide 21 or 23 may also be activated automatically or on a case-by-case basis. The flow rates or pressures of the machining fluids from the first wire guide 21 and the second wire guide 23 can be set independently.

### Third Embodiment

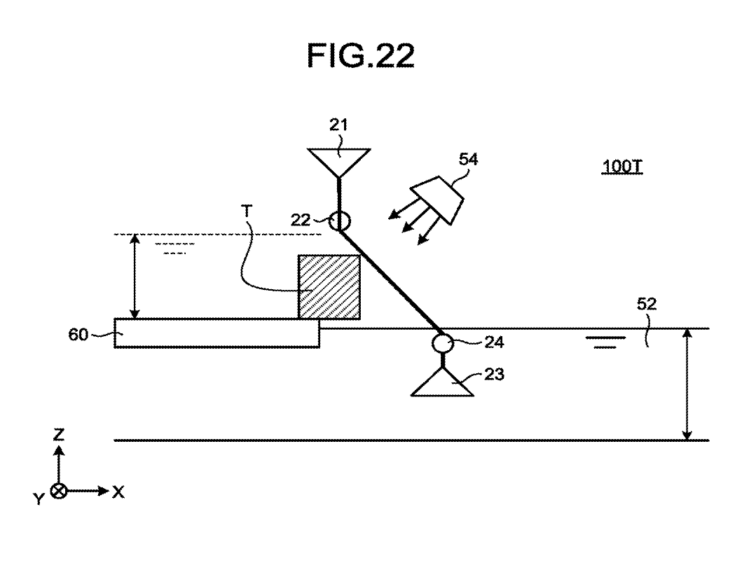

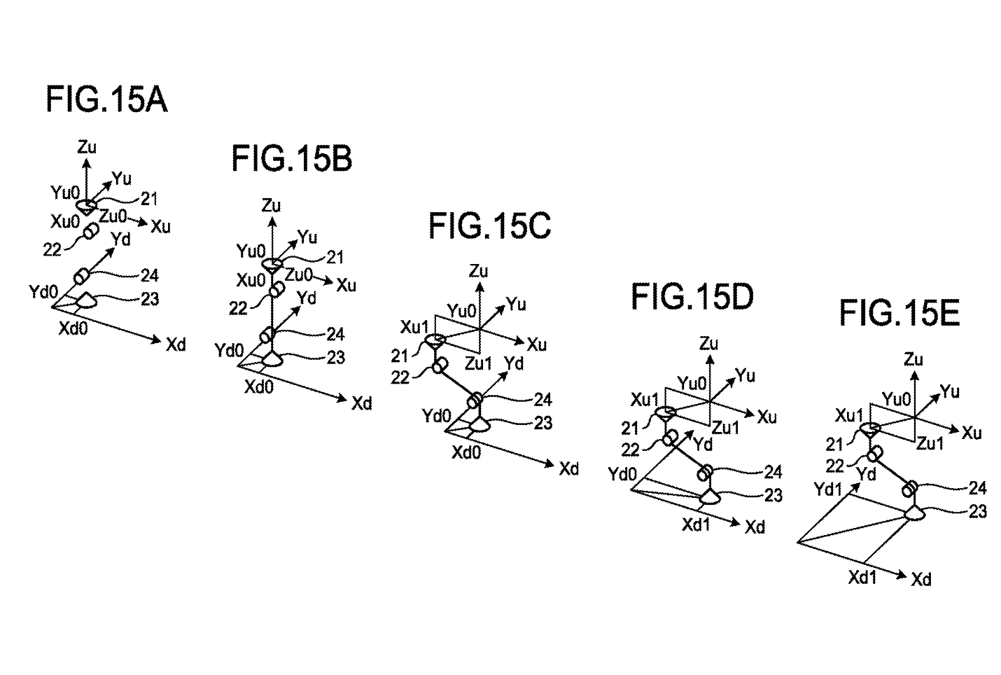

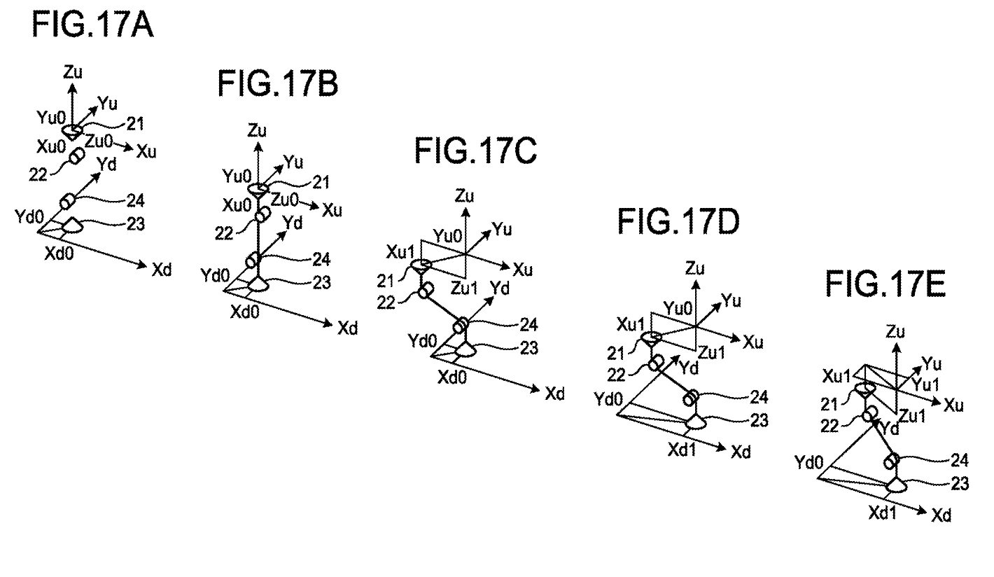

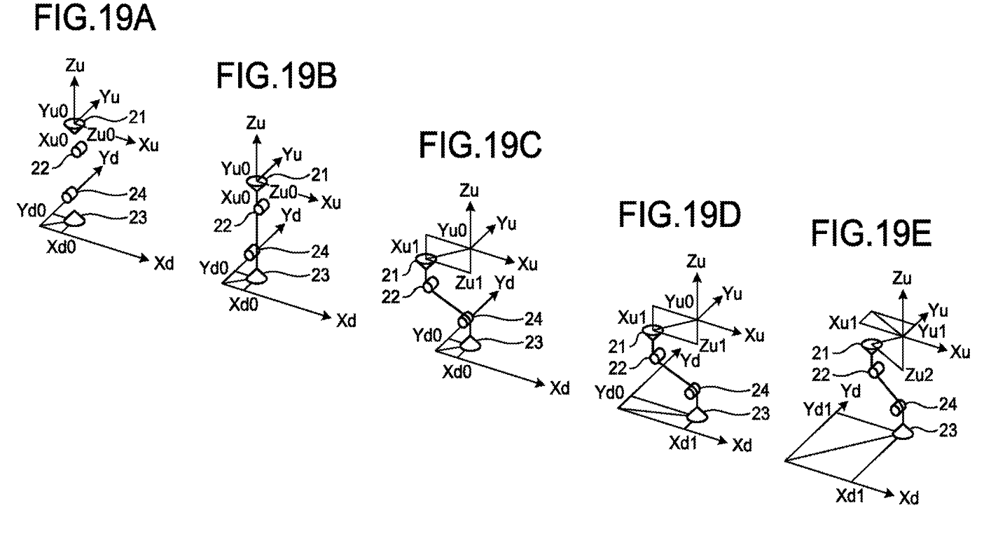

FIG. 22 is an illustrative diagram illustrating a wire electric discharge machine for use in a wire electric discharge machining method according to a third embodiment of the present invention. A wire electric discharge machine 100T of the third embodiment includes an injector 54 that ejects the machining fluid 52 to spray the machining fluid 52 selectively onto the machinable range section Rₚ of the wire electrode 1. Similarly to a typical wire electric discharge machine, the machining fluid 52 can be sprayed or ejected from the first and second wire guides 21 and 23 during machining. If the workpiece T has a portion that should not be dipped in the machining fluid for purposes of rust prevention or corrosion prevention, a configuration to make the machining fluid level situated at or below a portion at which the moving wire electrode 1 is subjected to actual machining as illustrated in FIG. 22 enables machining to be performed with spraying the machining fluid 52 without dipping the workpiece T in the machining fluid unlike a conventional wire electric discharge machine.

The wire electric discharge machine 100T of the third embodiment is characterized by the method of fixing the workpiece T, wherein its machine configuration including the guide unit 20 is similar to that of the wire electric discharge machine 100 of the first embodiment. The wire electric discharge machine 1001 of the third embodiment is configured such that a wire electric discharge machine that causes the wire electrode 1 to move vertically is provided additionally with the guide unit 20 having two support points, thereby to set the wire electrode 1 to be in the horizontal direction, and make changeable the position and direction of the wire electrode 1 while a long workpiece T is fixed by the gripper 62 of the fixture jig 60 with the longitudinal direction of the workplace being kept in the vertical direction, thus to perform electric discharge machining of the workplace T while the machining direction is changed.

The wire electric discharge machine 100T of the third embodiment enables the machining fluid 52 to be sprayed during the machining. If the workpiece T has a portion that should not be dipped in the machining fluid 52 for purposes of rust prevention or corrosion prevention, a configuration to make the machining fluid level of the machining fluid 52 situated at or below a surface for the moving wire electrode 1 enables machining to be performed with the machining fluid being sprayed without dip of the workpiece T.

Although the foregoing embodiments are described in which the first and second wire guide units use the through-holes that allow the wire electrode to penetrate and the first and second support elements are formed using guide rollers that come in contact with the wire electrode, the present invention is not limited to these embodiments, but any means that determines the direction of the wire electrode, including a passing-thorough groove, may be used. It suffices that the second support element be disposed spaced apart from the second wire guide and be configured to define a passage location of the wire electrode so that a line segment connecting the first and second support elements can tilt. Herein, the first and second support elements mean points that are in contact with the wire electrode, and correspond to contact points with guide rollers if the guide rollers form the first and second support elements. In addition, if the first and second support elements are formed by guide holes through which the wire electrode is passed, the outlets of the guide holes are referred to as first and second support elements.

Although the foregoing embodiments are described in which the set of the first wire guide unit and first support element and the set of the second wire guide unit and the second support element are driven by one and the same drive system, these sets may be configured to be movable by independent drive systems, respectively. For example, it is possible that the set of the first wire guide unit and the first support element and the set of the second wire guide unit and the second support element are each supported by an independent support rod, and are each remotely actuated by an independent control system, or otherwise, various other manners of control may be realised therefor.

The configurations described in the foregoing embodiments are merely examples of various aspects of the present invention, and may be combined with other publicly known techniques and partially omitted and/or modified without departing from the spirit of the present invention.

### REFERENCE SIGNS LIST

1 wire electrode; 10 supply unit; 11 wire supply reel; 11M supply motor; 12 wire tension control roller; 13 automatic connection unit; 20 guide unit; 20U first unit; 20D second unit; 21 first wire guide; 22 first support element; 21h through-hole; 22R first guide roller; 23 second wire guide; 23h through-hole; 24 second support element; 24R second guide roller; 25 first attachment plate; 26 first arm; 27 second attachment plate; 28 second arm; 30 electricity supply unit; 31 power supply; 32 feeder line; 33 feed element; 40 collection unit; 41 lower nozzle; 42 roller; 43 wire electrode collection roller; 43M collection motor; 50 fluid tank unit; 51 fluid tank; 52 machining fluid; 53 liquid level adjuster; 60 fixture jig; 61 main body; 62 gripper; 70 first drive system; 71 first horizontal drive; 72 first vertical drive; 73 first vertical drive motor; 74 first horizontal drive motor; 75 first support rod; 80 second drive system; 81 second horizontal drive; 84X second X-direction horizontal drive motor; 84Y second Y-direction horizontal drive motor; 85 second support rod; 100, 100S, 100T wire electric discharge machine; Rₚ machinable range section.

1. A wire electric discharge machine comprising:
a supply unit to supply a wire electrode; and
a wire guide unit to stretch the wire electrode in motion supplied from the supply unit, and guide the wire electrode to a machinable range section where a workpiece is placed,
wherein the wire guide unit includes:
a first wire guide;
a second wire guide disposed spaced apart from the first wire guide and movable relative to the first wire guide;
a first support element disposed spaced apart from the first wire guide between the first wire guide and the second wire guide to determine a passage location of the wire electrode; and
a second support element disposed spaced apart from the second wire guide to determine a passage location of the wire electrode and control a tilt of a line segment connecting the first and second support elements, and
wherein the first wire guide is fixed to a first unit body and the first support element is attached to a first arm rotatably supported by the first unit body, so as to constitute a first unit, and
the second wire guide is fixed to a second unit body and the second support element is attached to a second arm rotatably supported by the second unit body, so as to constitute a second unit.

2-3. (canceled)

4. The wire electric discharge machine according to claim 1, wherein
the first unit and the second unit are each movable independently.

5. The wire electric discharge machine according to claim 1, wherein
the first wire guide and the second wire guide each include a through-hole that allows the wire electrode to penetrate therein in a direction in which the electrode has been supplied, and circumferentially guides the wire electrode, and
the first support element and the second support element are formed by first and second guide rollers that each make contact with the wire electrode supplied through the first wire guide and determine a passage location of the wire electrode by being in butt-contact with the wire electrode.

6. (canceled)

7. The wire electric discharge machine according to claim 1, wherein the first arm or the second arm has a variable length.

8. The wire electric discharge machine according to claim 1, comprising a fluid tank surrounding the machinable range section.

9. The wire electric discharge machine according to claim 1, comprising a workpiece fixture jig to fix a machined portion of the workpiece, the workpiece fixture jig facing the wire electrode in the machinable range section.

10. The wire electric discharge machine according to claim 1, comprising a fluid supply nozzle to supply a fluid to a portion where a machined portion of the workpiece and the wire electrode face each other in the machinable range section.

11. The wire electric discharge machine according to claim 1, comprising:
a first drive system to drive the first unit;
a second drive system to drive the second unit; and
a control unit to control the first drive system and the second drive system,
wherein the control unit includes a storage unit to store positional information of the first unit and the second units unit.

12. A guide unit attached to a wire electric discharge machine that processes a workpiece by wire electric discharge, to adjust a moving direction of a wire electrode in motion supplied from a supply unit that supplies the wire electrode, the guide unit comprising:
a first wire guide;
a second wire guide disposed spaced apart from the first wire guide and movable relative to the first wire guide;
a first support element, disposed spaced apart from the first wire guide between the first wire guide and the second wire guide, to determine a passage location of the wire electrode; and
a second support element, disposed spaced apart from the second wire guide, which determines a passage location of the wire electrode and controls a tilt of a line segment connecting the first and second support elements, and
wherein the first wire guide is fixed to a first unit body and the first support element is attached to a first arm rotatably supported by the first unit body, so as to constitute a first unit, and
the second wire guide is fixed to a second unit body and the second support element is attached to a second arm rotatably supported by the second unit body, so as to constitute a second unit.

13-14. (canceled)

15. The guide unit according to claim 12,
wherein the first unit and the second unit are each movable independently.

16. The guide unit according to claim 12, wherein
the first wire guide and the second wire guide each include a through-hole that allows the wire electrode to penetrate therein in a direction in which the electrode has been supplied, and circumferentially guides the wire electrode, and
the first support element and the second support element are formed by first and second guide rollers that each make contact with the wire electrode supplied through the first wire guide to direct the wire electrode to a different direction.

17. (canceled)

18. The guide unit according to claim 12, wherein the first arm or the second arm has a variable length.

19. A wire electric discharge machining method using a wire electric discharge machine including a wire guide unit to stretch a wire electrode in motion supplied from a supply unit, and guide the wire electrode to a machinable range section where a workpiece is placed,
wherein the wire guide unit includes:
a first wire guide;
a second wire guide disposed spaced apart from the first wire guide and movable relative to the first wire guide;
a first support element, disposed spaced apart from the first wire guide between the first wire guide and the second wire guide, which determines a passage location of the wire electrode; and
a second support element disposed spaced apart from the second wire guide, which determines a passage location of the wire electrode and controls a tilt of a line segment connecting the first and second support elements, and
wherein the first wire guide is fixed to a first unit body and the first support element is attached to a first arm rotatably supported by the first unit body, so as to constitute a first unit, and
the second wire guide is fixed to a second unit body and the second support element is attached to a second arm rotatably supported by the second unit body, so as to constitute a second unit,
the method comprising:
a step of machining the workpiece while controlling a tilt of a portion of the wire electrode, the portion being stretched between the first support element and the second support element.

20. The wire electric discharge machining method according to claim 19,
wherein
the step of machining includes a machining step of moving the first unit and the second unit relative to each other and performing electric discharge machining while changing a tilt of the machinable range section of the wire electrode.

21. The wire electric discharge machining method according to claim 20, wherein the machining step includes a machining step in a main coordinate system, in which machining is performed while the first wire guide and the second wire guide maintain a certain machining range.

22. The wire electric discharge machining method according to claim 20, wherein the machining step includes a machining step in an auxiliary coordinate system, in which the second wire guide is fixed, and the first wire guide is operated and driven.

23. The wire electric discharge machining method according to claim 20, wherein the machining step includes a machining step in an auxiliary coordinate system, in which the first wire guide is fixed, and the second wire guide is operated and driven.

24. The wire electric discharge machining method according to claim 20, comprising:
a connection step of passing the wire electrode through the first wire guide and the second wire guide of the wire guide unit before the machining step; and
a collection step of collecting the wire electrode after the machining step,
wherein the connection step, the machining step, and the collection step are consecutively performed.

25. The wire electric discharge machining method according to claim 24, wherein
the wire electric discharge machine includes a control unit to store positional information of the wire guide unit, and control a position of the wire guide unit, and
the machining step is a step of performing machining while storing the positional information of the wire guide unit during machining in the control unit,
in which the connection step is carried out after breakage of the wire electrode, and
which includes a returning step of returning the wire guide unit to a machining position based on the stored positional information, after the connection step.
